(19) United States
(12) Patent Application Publication
(10) Pub. No.: US 2021/0205955 A1
(43) Pub. Date: Jul. 8, 2021

(54) UNIVERSAL BLAST HANDLE MOUNT

(71) Applicant: Graco Minnesota Inc., Minneapolis, MN (US)

(72) Inventors: Daniel P. Ross, Vadnais Heights, MN (US); Jacob R. Whiteoak, Blaine, MN (US)

(73) Assignee: Graco Minnesota Inc.

(21) Appl. No.: 16/073,486

(22) PCT Filed: Feb. 20, 2017
(86) PCT No.: PCT/US2017/018576

§ 371 Date: Jul. 27, 2018

Related U.S. Application Data
(60) Provisional application No. 62/299,659, filed on Feb. 25, 2016.

(51) Int. Cl. B24C 3/06; B25G 1/00; B24C 5/04

(52) U.S. Cl. CPC B24C 3/06; B24C 5/04; B25G 1/005

(57) ABSTRACT

A mounting assembly includes a center block, first and second brackets, and a fastener configured to attach the first bracket and the second bracket to the center block. The first and second brackets respectively include first and second major faces, first and second minor faces, first and second sets of through holes, and first and second sets of mounting features. The first and second minor faces are respectively connected to the first and second major faces at approximately 90° angles. The first and second sets of through holes are respectively disposed in the first and second major faces. The first and second sets of mounting features are respectively disposed in the first and second minor faces.

### CROSS-REFERENCE TO RELATED APPLICATION

This application claims priority to U.S. Provisional Application No. 62/299,659 filed on Feb. 25, 2016, and entitled “UNIVERSAL BLAST HANDLE MOUNT,” the entire contents of which are hereby incorporated by reference in their entirety.

### BACKGROUND

The present disclosure relates to abrasive blasting systems, and more particularly, to a handle mounting assembly for an abrasive blasting system.

Blasting systems in the surface preparation industry generally use dry, wet, slurry, vapor abrasive, or ultra-high pressure water blast technologies to remove dirt, paint, or rust from a substrate. Vapor blast systems use a mixture of air, water, and/or abrasive media to provide the desired surface treatment. Vapor blast systems often include a pump and a pressure vessel containing an abrasive media having a density greater than water. Pumping water to the pressure vessel pressurizes the pressure vessel and allows the abrasive media and water to mix. The pressurized media and water mixture is then plumbed into a conduit of a high flowing air stream to mix the two streams before expelling the mixture from a hose and a blast nozzle.

Blasting in general is a very laborious job that requires a user to carry the weight of the end of a blast hose and in addition to resist the force of the low pressure, high flow of the blast media. Traditionally, blast hoses are propped under the arm or over the shoulder of the user to support some the weight of the hose. The blast nozzle is usually held by hand and typically while wearing gloves to protect the user from high temperatures. The blast hose also applies a large force back onto the user when media is expelled from the hose, which causes the user to become fatigued.

### SUMMARY

A mounting assembly includes a center block, first and second brackets, and a fastener configured to attach the first bracket and the second bracket to the center block. The first and second brackets respectively include first and second major faces, first and second minor faces, first and second sets of through holes, and first and second sets of mounting features. The first and second minor faces are respectively connected to the first and second major faces at approximately 90° angles. The first and second sets of through holes are respectively disposed in the first and second major faces. The first and second sets of mounting features are respectively disposed in the first and second minor faces.

A mounting assembly for a blast nozzle includes a center block, first and second brackets, a fastener configured to attach the first bracket and the second bracket to the center block, and a handle assembly. The first and second brackets respectively include first and second major faces, first and second minor faces, first and second sets of through holes, and first and second sets of mounting features. The first and second minor faces are respectively connected to the first and second major faces at approximately 90° angles. The first and second sets of through holes are respectively disposed in the first and second major faces. The first and second sets of mounting features are respectively disposed in the first and second minor faces. The assembly attached to at least one of the first bracket and the second bracket and includes a grip and an attachment portion mounted onto the grip.

A method includes providing a mounting assembly that includes a center block, first and second brackets, a fastener configured to attach the first bracket and the second bracket to the center block, and a handle assembly configured to prevent rotation of the mounting assembly. The center block includes a generally cylindrical opening and an attachment passage configured to receive a portion of a fastener. The first and second brackets respectively include first and second major faces, first and second minor faces, first and second sets of through holes, and first and second sets of mounting features. The first and second minor faces are respectively connected to the first and second major faces at approximately 90° angles. The first and second sets of through holes are respectively disposed in the first and second major faces. The first and second sets of mounting features are respectively disposed in the first and second minor faces. The first bracket and the second bracket are attached to the center block with the fastener. The mounting assembly is mounted onto a blast nozzle. The blast nozzle is received into the generally cylindrical opening of the center block. The mounting assembly is clamped onto the blast nozzle by compressing the center block with the first bracket and the second bracket.

A method of blasting includes mounting a mounting assembly onto a blast nozzle. The mounting assembly includes a center block, first and second brackets, a fastener configured to attach the first bracket and the second bracket to the center block, and a handle assembly attached to at least one of the first bracket and the second bracket. The center block includes a generally cylindrical opening and an attachment passage configured to receive a portion of the fastener. The first and second brackets respectively include first and second major faces, first and second minor faces, first and second sets of through holes, and first and second sets of mounting features. The first and second minor faces are respectively connected to the first and second major faces at approximately 90° angles. The first and second sets of through holes are respectively disposed in the first and second major faces. The first and second sets of mounting features are respectively disposed in the first and second minor faces. The handle assembly is configured to prevent rotation of the mounting assembly. The mounting assembly is grasped. Blast media is expelled out of the blast nozzle. Rotation of the mounting assembly is prevented by absorbing torque with the handle assembly.

### BRIEF DESCRIPTION OF THE DRAWINGS

FIG. 1A is an exploded view of a mounting assembly.

FIG. 1B is a perspective view of the mounting assembly and a blast nozzle.

FIG. 2A is a perspective view of another mounting assembly with a first handle assembly.

FIG. 2B a perspective view of a blast nozzle and the mounting assembly with the first handle assembly.

FIG. 3A is a perspective view of yet another mounting assembly and a second handle assembly.

FIG. 3B is a perspective view of a blast nozzle and the mounting assembly with the second handle assembly.

FIG. 4 is a flowchart of a method.

FIG. 5 is a flowchart of a method of blasting.

### DETAILED DESCRIPTION

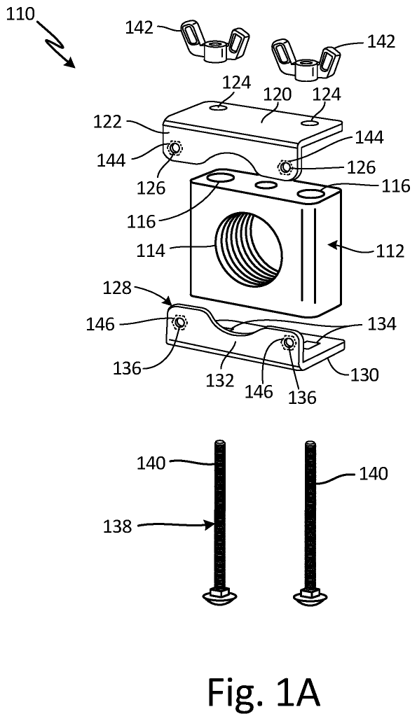

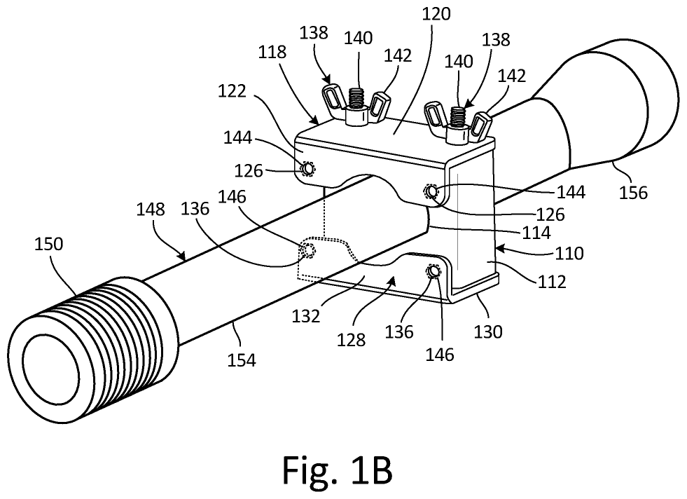

FIG. 1A is an exploded view of mounting assembly 110 which includes center block 112 (with opening 114 and attachment passages 116), first bracket 118 (with first major face 120, first minor face 122, first set of through holes 124, and first set of mounting features 126), second bracket 128 (with second major face 130, second minor face 132, second set of through holes 134, second set of mounting features 136), fasteners 138 (with first bolts 140 and wingnuts 142), first set of nuts 144, and second set of nuts 146. FIG. 1B is a perspective view of mounting assembly 110 and blast nozzle 148. In addition to the elements shown in FIG. 1A, FIG. 1B shows blast nozzle 148 with outlet 150, inlet 152, and pipe portion 154 extending between outlet 150 and inlet 152. FIGS. 1A and 1B show similar elements and will be discussed in unison.

Mounting assembly 110 is an assembly of elements for mounting onto a blast nozzle of an abrasive blasting system. Center block 112 is a block of deformable solid material. In one non-limiting embodiment, the material of center block 112 can include rubber. In another non-limiting embodiment, the material of center block 112 can include at least one of plastic, composite, polymer, elastomer, or other forms of deformable solid materials. In other non-limiting embodiments, center block 112 can include two or more pieces. Opening 114 is a cylindrically shaped passage extending through a middle portion of center block 112. Attachment passages 116 are channels or holes extending through center block 112 in a direction generally perpendicular to opening 114.

First bracket 118 and second bracket 128 are L-shaped pieces of flat, solid material. In one non-limiting embodiment, the material of first bracket 118 or second bracket 128 can include a metal such as steel or aluminum. In another non-limiting embodiment, first bracket 118 and/or second bracket 128 can comprise a single piece of material or multiple pieces attached and/or affixed together. In other non-limiting embodiments, first bracket 118 and/or second bracket 128 can include other shapes and/or configurations such as more than two faces with which to engage center block 112.

First major face 120 and first minor face 122 are portions of first bracket 118. First set of through holes 124 is a set of holes disposed in first major face 120. First set of mounting features 126 is a set of holes disposed in first minor face 122. Second major face 130 and second minor face 132 are portions of second bracket 128. Second set of through holes 134 is a set of holes disposed in second major face 130. Second set of mounting features 136 is a set of holes disposed in second minor face 132.

Fasteners 138 are mechanical devices for attachment. First bolts 140 are threaded pins or bars. Wingnuts 142 are threaded nuts with wings, or projections, extending outwards to enable a user to tighten or loosen wingnuts 142 with their fingers. First set of nuts 144 and second set of nuts 146 are sets of threaded nuts. In one non-limiting embodiment, first set of nuts 144 and second set of nuts 146 can be self-locking or self-clinching fasteners.

Blast nozzle 148 (shown in FIG. 1B) is a nozzle of an abrasive blasting system. In other non-limiting embodiments, blast nozzle 148 can include other elements of an abrasive blast system such as a blast nozzle extension or blast hose. Outlet 150 is an outlet of blast nozzle 148. Inlet 152 is an inlet of blast nozzle 148. Pipe portion 154 is a portion of blast nozzle 148 extending between outlet 150 and inlet 152.

Mounting assembly 110 is configured to clamp onto at least one of blast nozzle 148 and a blast nozzle extension of an abrasive blasting system. Mounting assembly 110 is also configured to compress center block 112. Center block 112 is disposed between first major face 120 of first bracket 118 and second major face 130 of second bracket 128 such that center block 112 is compressed between first bracket 118 and second bracket 128. Opening 114 extends completely through center block 112 and is configured to receive blast nozzle 148. As shown in FIG. 1B, pipe portion 154 of blast nozzle 148 is positioned in opening 114 of center block 112. Attachment passages 116 extend through center block 112 and are configured to receive portions of fasteners 138 such as first bolts 140.

First bracket 118 is in contact with center block 112 such that center block 112 is compressed between first bracket 118 and second bracket 128. First major face 120 is connected to and forms a single element with first minor face 122. First minor face 122 is connected to first major face 120 at approximately a 90° angle. First set of through holes 124 is disposed in and extends through first major face 120. First set of mounting features 126 is disposed in and extends through first minor face 122. Second bracket 128 is in contact with center block 112 such that center block 112 is compressed between first bracket 118 and second bracket 128. Second major face 130 comes into contact with center block on an opposite side of center block 112 than first major face 120. Second minor face 132 is connected to second major face 130 at approximately a 90° angle. Second set of through holes 134 is disposed in and extends through second major face 130. Second set of mounting features 136 is disposed in and extends through second minor face 132.

Fasteners 138 are disposed in attachment passages 116 and are configured to attach first bracket 118 and second bracket 128 to center block 112. Fasteners 138 attach first bracket 118 and second bracket 128 to center block 112 by compressing first bracket 118 and second bracket 128 onto center block 112. First bolts 140 are disposed in and extend through second set of through holes 134 in second major face 130 of second bracket 128, through attachment passages 116 of center block 112, and through first set of through holes 124 in first major face 120 of first bracket 118. First bolts 140 are received by attachment passages 116 of center block 112. Wingnuts 142 are threadably attached to ends of first bolts 140. With mounting assembly 110 in a mounted or compressed state, wingnuts 142 are in contact with first major face 120 so as to compress first bracket 118 (and second bracket 128) into center block 112.

Each nut of first set of nuts 144 is disposed between first minor face 122 of first bracket 118 and center block 112 such that an opening of each nut of first set of nuts 144 is aligned with a mounting feature of first set of mounting features 126. In one non-limiting embodiment, first set of nuts 144 can be pressed or welded onto first minor face 122 of first bracket 118. Each nut of second set of nuts 146 is disposed between second minor face 132 of second bracket 128 and center block 112 such that an opening of each nut of second set of nuts 146 is aligned with a mounting feature of second set of mounting features 136. In one non-limiting embodiment, second set of nuts 146 can be pressed or welded onto second minor face 132 of second bracket 128.

Blast nozzle 148 is attached to mounting assembly 110 by way of mounting assembly 110 being mounted onto blast nozzle 148. In one non-limiting embodiment, blast nozzle 148 is attached and fluidly connected to a blasting system via a blast hose. Outlet 150 is fluidly connected to pipe portion 154 and is disposed on an end of blast nozzle 148 opposite from inlet 152. Inlet 152 is fluidly connected to pipe portion 154 and is disposed on an end of blast nozzle 148 opposite from outlet 150. Pipe portion 154 is fluidly connected to and disposed between outlet 150 and inlet 152.

As can be seen in FIG. 1B, mounting assembly 110 attaches or is clamped onto blast nozzle 148 by fasteners 138 attaching first bracket 118 and second bracket 128 to center block 112. As fasteners 138 are tightened (e.g., wingnuts 142 rotatably activate with first bolts 140), fasteners 138 draw first bracket 118 and second bracket 128 towards one another and compress, or squeeze, center block 112. With center block 112 compressed onto pipe portion 154 of blast nozzle 148, an additional frictional force is applied to blast nozzle 148 by center block 112. With the additional frictional force center block 112 applies to blast nozzle 148, center block 112 is prevented from movement (e.g., rotational and/or axial) relative to blast nozzle 148. In addition to preventing relative motion between mounting assembly 110 and blast nozzle 148, center block 112 also absorbs vibrational and thermal energies from blast nozzle 148.

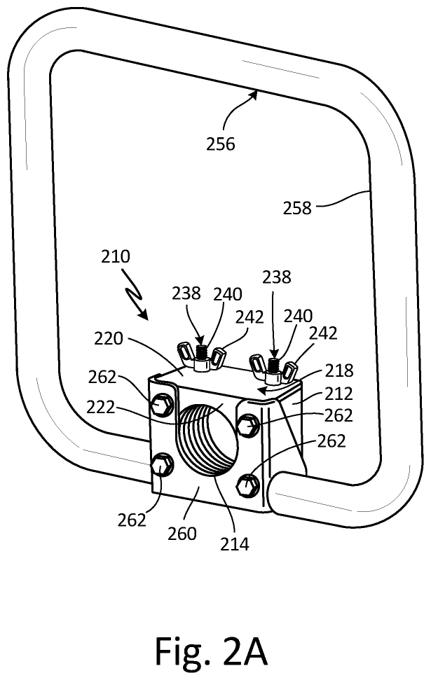

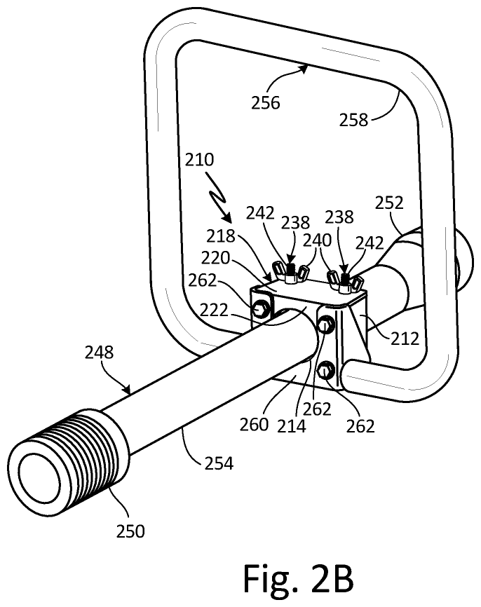

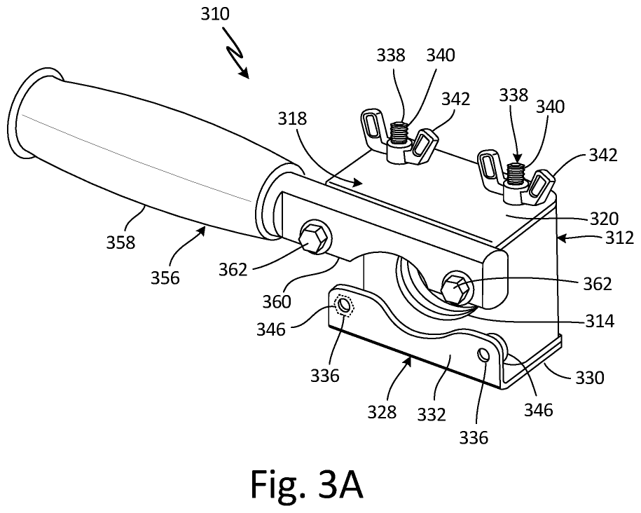

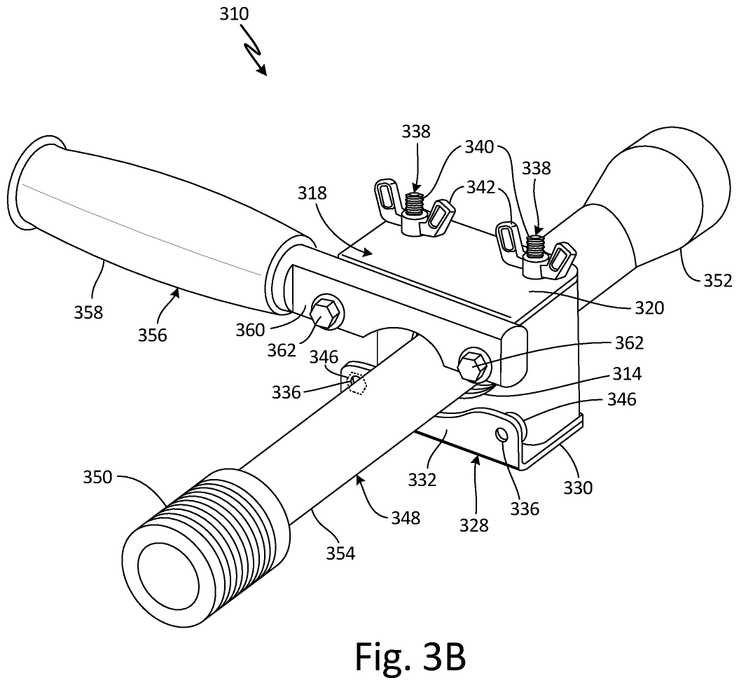

Mounting assembly 110 provides a universal mounting location for blast equipment nozzles and nozzle extensions. Mounting assembly 110 requires no tools to mount or pivot while in use (e.g., the user is able to hand-tighten wingnuts 142 of fasteners 138). This provides the user (e.g., person performing application of the blast) the ability to assemble or modify mounting assembly 110 on the fly, while wearing gloves, or while in transient working environments such as on a scaffold. Mounting assembly 110 does not require a specific handle and can be used with any handle assembly configuration that can be mounted to the generic bolt pattern of first and second sets of mounting features 126 and 136 on first and second brackets 118 and 128, respectively. When being used in conjunction with a handle assembly (see e.g., FIGS. 2A-3B), mounting assembly 110 can be oriented (or re-oriented) to the user's preference with respect to the often rigid blast hose attached to blast nozzle 148 (or a nozzle extension). Giving the user a mounting place for a handle assembly allows the user to vary their grip on blast nozzle 148 (or the nozzle extension) reducing fatigue on the user. Additionally, with mounting assembly absorbing vibrational and thermal energies from blast nozzle 148, fatigue on the user is further reduced as well as preventing the user from grasping an overheated blast nozzle.

FIG. 2A shows a perspective view of mounting assembly 210 with first handle assembly 256. FIG. 2B shows a perspective view of mounting assembly 210 with first handle assembly 256 and blast nozzle 248. The elements shown in FIGS. 2A and 2B are similar to those discussed with respect to FIGS. 1A and 1B, for example mounting assembly 210 and its elements are similar to mounting assembly 110. Given this, the description of mounting assembly 110 and its elements also applies to mounting assembly 210 and its corresponding elements.

Mounting assembly 210 includes center block 212 (with opening 214 and attachment passages 216), first bracket 218 (with first major face 220, first minor face 222, first set of through holes 224, and first set of mounting features 226), second bracket 228 (with second major face 230, second minor face 232, second set of through holes 234, second set of mounting features 236), fasteners 238 (with first bolts 240 and wingnuts 242), first set of nuts 244, and second set of nuts 246. FIG. 2B is a perspective view of mounting assembly 210 and blast nozzle 248. In addition to the elements shown in FIG. 2A, FIG. 2B shows blast nozzle 248 with outlet 250, inlet 252, and pipe portion 254 extending between outlet 250 and inlet 252. FIGS. 2A and 2B show similar elements and will be discussed in unison. FIGS. 2A and 2B also show first handle assembly 256 (with grip 258, attachment portion 260, and second bolts 262).

First handle assembly 256 is an assembly of grip 258, attachment portion 260, and second bolts 262. Grip 258 is a square-shaped handle made of solid material. In other non-limiting embodiments, a shape and/or configuration of grip 258 can be flat, circular (e.g., steering wheel), figure-eight, or another ergonomic shape allowing a user or a plurality of users to grasp grip 258. Attachment portion 260 is a bracket connected to grip 258. Second bolts 262 are threaded fasteners.

Grip 258 and attachment portion 260 are attached together via welding. In one non-limiting embodiment, grip 258 can be mechanically attached or otherwise fastened to attachment portion 260. In another non-limiting embodiment, grip 258 and attachment portion 260 can be made of a unitary, continuous piece of material such as aluminum or steel.

Attachment portion 260 is attached to mounting assembly 210 via second bolts 262. Second bolts 262 extend through attachment portion 260 and engage with mounting assembly 210. In one non-limiting embodiment, second bolts 262 pass through attachment portion 260 and insert into and threadably engage with first set of mounting features 226 of first minor face 222 and second set of mounting features of second minor face 232. In other non-limiting embodiments, attachment portion 260 can be mounted to mounting assembly 210 via engagement with fasteners 238.

First handle assembly 256 is configured such that mounting assembly 210, and correspondingly blast nozzle 248, is located on a perimeter of grip 258. The location of mounting assembly 210 along a perimeter of grip 258 allows the user to grasp first handle assembly 256 at a distance from blast nozzle 248 thereby increasing the amount of resistive torsional force the user is able to apply to counteract (e.g., absorb) the torque on blast nozzle 248 caused from the expulsion of blast media from blast nozzle 248.

A square-shaped configuration of grip 258 as shown in FIGS. 2A and 2B enables the user to grasp grip 258 with both hands, which prevents blast nozzle from rotating. Also, the tightening and clamping capability of mounting assembly 210 enables mounting assembly 210 to easily disengage from blast nozzle 248 and mounting assembly 210 to be moved to a different location on blast nozzle 248, a blast nozzle extension, or on a blast hose. In other non-limiting embodiments, multiple of mounting assemblies 210 with handle assemblies 256 can be disposed of blast nozzle 248, blast nozzle extension, and/or blast hose to provide incremental support along any of blast nozzle 248, a blast nozzle extension, and/or a blast hose.

FIG. 3A shows a perspective view of mounting assembly 310 with first handle assembly 356. FIG. 3B shows a perspective view of mounting assembly 310 with first handle assembly 356 and blast nozzle 348. The elements shown in FIGS. 3A and 3B are similar to those discussed with respect to FIGS. 1A-1B and 2A-2B, for example mounting assembly 310 and its elements are similar to mounting assemblies 110 and 210. Given this, the descriptions of mounting assemblies 110, 220 and their elements also apply to mounting assembly 310 and its corresponding elements.

Mounting assembly 310 includes center block 312 (with opening 314 and attachment passages 316), first bracket 318 (with first major face 320, first minor face 322, first set of through holes 324, and first set of mounting features 326), second bracket 328 (with second major face 330, second minor face 332, second set of through holes 334, second set of mounting features 336), fasteners 338 (with first bolts 340 and wingnuts 342), first set of nuts 344, and second set of nuts 346. FIG. 3B is a perspective view of mounting assembly 310 and blast nozzle 348. In addition to the elements shown in FIG. 3A, FIG. 3B shows blast nozzle 348 with outlet 350, inlet 352, and pipe portion 354 extending between outlet 350 and inlet 352. FIGS. 3A and 3B show similar elements and will be discussed in unison. FIGS. 3A and 3B also show second handle assembly 356 (with grip 358, attachment portion 360, and second bolts 362).

Second handle assembly 356 is an assembly of grip 358, attachment portion 360, and third bolts 362. Grip 358 is an elongated handle extending sideways (e.g., perpendicular) from mounting assembly 310. In another non-limiting embodiment, grip 358 can include more than one handle extending outwards from mounting assembly 310. In other non-limiting embodiments, a shape and/or configuration of grip 358 can be flat, circular (e.g., steering wheel), figure-eight, or another ergonomic shape allowing a user or a plurality of users to grasp grip 358. Attachment portion 360 is a bracket connected to grip 358. Third bolts 362 are threaded fasteners.

The configuration of grip 358 as shown in FIGS. 3A and 3B provides a handle solution for situations where control of blast nozzle 348 with a single hand by the user is desirable or required. In other non-limiting embodiments, the configuration and/or shape of grip 358 can be used with a blast application where the torque created from expulsion of blast media from blast nozzle 348 is relatively small (e.g., less than that of blast nozzle 248).

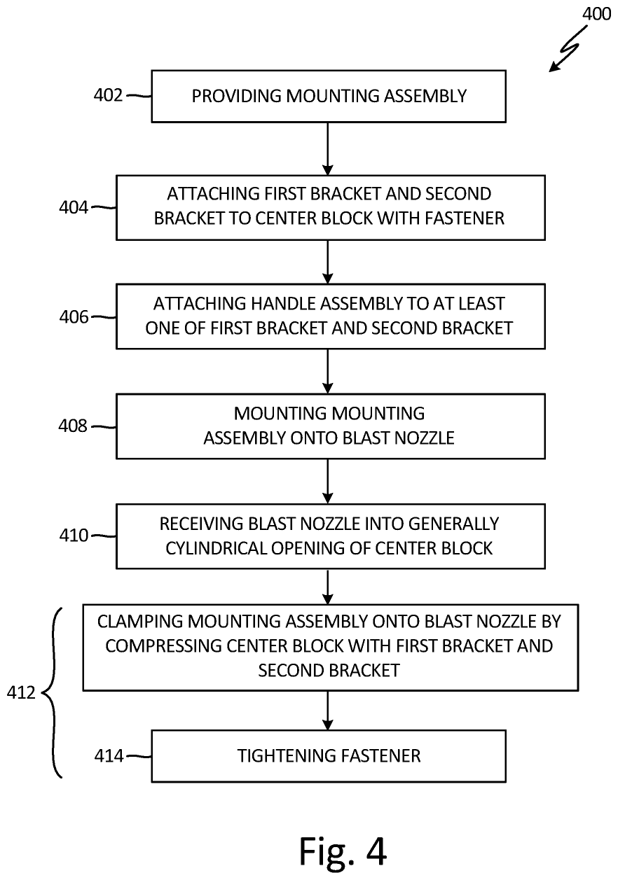

FIG. 4 is a flowchart of method 400, which includes steps 402-414. Step 402 includes providing a mounting assembly, such as any of mounting assemblies 110, 210, and/or 310. Step 404 includes attaching a handle assembly to at least one of a first bracket and a second bracket of the mounting assembly. In one non-limiting embodiment, step 404 can be performed before or after any of the other steps of method 400. Step 406 includes attaching the first bracket and the second bracket to a center block of the mounting assembly with a fastener. Step 408 includes mounting the mounting assembly onto a blast nozzle. Step 410 includes receiving the blast nozzle into a generally cylindrical opening of the center block. Step 412 includes clamping the mounting assembly onto the blast nozzle by compressing the center block with the first bracket and the second bracket. Step 412 additionally includes step 414. Step 414 includes tightening the fastener.

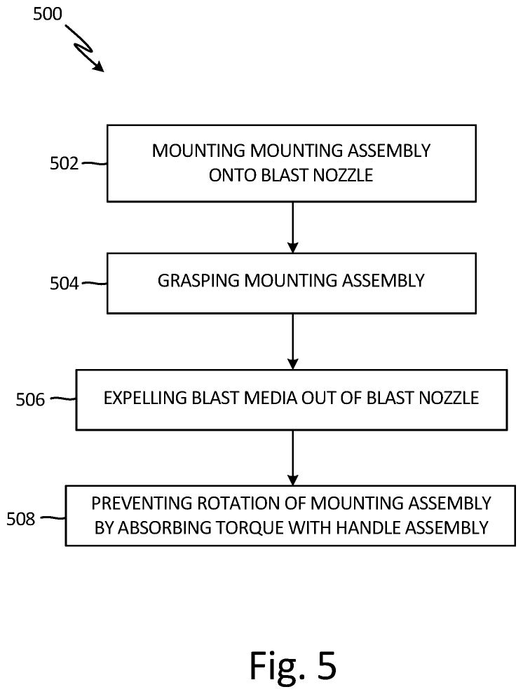

FIG. 5 is a flowchart of method 500 of blasting, which includes steps 502-508. Step 502 includes mounting a mounting assembly (e.g., such as any of mounting assemblies 110, 210, and/or 310) onto a blast nozzle of a blasting system. Step 504 includes grasping the mounting assembly. Step 506 includes expelling blast media out of the blast nozzle. Step 508 includes preventing rotation of the mounting assembly by absorbing torque with the handle assembly.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A mounting assembly comprising:
a center block;
a first bracket comprising:
a first major face;
a first minor face connected to the first major face at approximately a 90° angle;
a first set of through holes disposed in the first major face; and
a first set of mounting features disposed in the first minor face;
a second bracket comprising:
a second major face;
a second minor face connected to the second major face at approximately a 90° angle;
a second set of through holes disposed in the second major face; and
a second set of mounting features disposed in the second minor face; and
a fastener configured to attach the first bracket and the second bracket to the center block.

2. The mounting assembly of claim 1, wherein the mounting assembly is configured to clamp onto at least one of a blast nozzle and a blast nozzle extension.

3. The mounting assembly of claim 1, wherein the center block comprises a generally cylindrical opening and an attachment passage, wherein the attachment passage is configured to receive a portion of the fastener.

4. The mounting assembly of claim 1, wherein the mounting assembly is configured to compress the center block.

5. The mounting assembly of claim 1, wherein the first set of mounting features comprises a first set of mounting holes extending through the first minor face, and wherein the second set of mounting features comprises a second set of mounting holes extending through the second minor face.

6. The mounting assembly of claim 1 and further comprising a first set of nuts disposed between the first minor face of the first bracket and the center block, wherein each threaded nut of the first set of nuts is aligned with a mounting feature of the first set of mounting features.

7. The mounting assembly of claim 1 and further comprising a second set of nuts disposed between the second minor face of the second bracket and the center block, wherein each threaded nut of the second set of nuts is aligned with a mounting feature of the second set of mounting features.

8. A mounting assembly for a blast nozzle, the mounting assembly comprising:
a center block;
a first bracket comprising:
a first major face;
a first minor face connected to the first major face at approximately a 90° angle;
a first set of through holes disposed in the first major face; and
a first set of mounting features disposed in the first minor face;
a second bracket comprising:
a second major face;
a second minor face connected to the second major face at approximately a 90° angle;
a second set of through holes disposed in the second major face; and
a second set of mounting features disposed in the second minor face;
a fastener configured to attach the first bracket and the second bracket to the center block; and
a handle assembly attached to at least one of the first bracket and the second bracket, the handle assembly comprising:
a grip; and
an attachment portion mounted onto the grip.

9. The mounting assembly of claim 8, wherein the center block comprises a generally cylindrical opening and an attachment passage, wherein the cylindrical opening is configured to receive the blast nozzle and the attachment passage is configured to receive a portion of the fastener.

10. The mounting assembly of claim 8, wherein the blast nozzle comprises a blast nozzle extension.

11. The mounting assembly of claim 8, wherein the attachment portion of the handle is attached to at least one of the first bracket and the second bracket.

12. The mounting assembly of claim 8, wherein the mounting assembly is configured to prevent rotation of the nozzle along at least one of an axial direction and a radial direction of the nozzle.

13. The mounting assembly of claim 8, wherein the mounting assembly is configured to compress the center block.

14. The mounting assembly of claim 8, wherein the first set of mounting features comprises a first set of mounting holes extending through the first minor face, and wherein the second set of mounting features comprises a second set of mounting holes extending through the second minor face.

15. The mounting assembly of claim 8 and further comprising a first set of nuts disposed between the first minor face of the first bracket and the center block, wherein each threaded nut of the first set of nuts is aligned with a mounting feature of the first set of mounting features.

16. The mounting assembly of claim 8 and further comprising a second set of nuts disposed between the second minor face of the second bracket and the center block, wherein each threaded nut of the second set of nuts is aligned with a mounting feature of the second set of mounting features.

17. A method comprising:
providing a mounting assembly comprising:
a center block comprising:
a generally cylindrical opening; and
an attachment passage configured to receive a portion of a fastener;
a first bracket comprising:
a first major face;
a first minor face connected to the first major face at approximately a 90° angle;
a first set of through holes disposed in the first major face; and
a first set of mounting features disposed in the first minor face;
a second bracket comprising:
a second major face;
a second minor face connected to the second major face at approximately a 90° angle;
a second set of through holes disposed in the second major face; and
a second set of mounting features disposed in the second minor face;
the fastener configured to attach the first bracket and the second bracket to the center block; and
a handle assembly configured to prevent rotation of the mounting assembly;
attaching the first bracket and the second bracket to the center block with the fastener; and
mounting the mounting assembly onto a blast nozzle, wherein mounting the mounting assembly comprises:
receiving the blast nozzle into the generally cylindrical opening of the center block; and
clamping the mounting assembly onto the blast nozzle by compressing the center block with the first bracket and the second bracket.

18. The method of claim 17 and further comprising attaching the handle assembly to at least one of the first bracket and the second bracket.

19. The method of claim 17, wherein compressing the center block with the first bracket and the second bracket comprises tightening the fastener.

20. A method of blasting, the method comprising:
mounting a mounting assembly onto a blast nozzle, the mounting assembly comprising:
a center block comprising:
a generally cylindrical opening; and
an attachment passage configured to receive a portion of a fastener;
a first bracket comprising:
a first major face;
a first minor face connected to the first major face at approximately a 90° angle;
a first set of through holes disposed in the first major face; and
a first set of mounting features disposed in the first minor face;
a second bracket comprising:
a second major face;
a second minor face connected to the second major face at approximately a 90° angle;
a second set of through holes disposed in the second major face; and
a second set of mounting features disposed in the second minor face;
the fastener configured to attach the first bracket and the second bracket to the center block; and
a handle assembly attached to at least one of the first bracket and the second bracket, wherein the handle assembly is configured to prevent rotation of the mounting assembly;
grasping the mounting assembly;
expelling blast media out of the blast nozzle; and
preventing rotation of the mounting assembly by absorbing torque with the handle assembly.
